(19) United States
(12) Patent Application Publication
(10) Pub. No.: US 2023/0370151 A1
(43) Pub. Date: Nov. 16, 2023

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/350,408

(22) Filed: Jul. 11, 2023

Related U.S. Application Data
(63) Continuation of application No. PCT/JP2022/000640, filed on Jan. 12, 2022.
(60) Provisional application No. 63/136,472, filed on Jan. 12, 2021.

(51) Int. Cl. H04B 7/155; H04W 40/24; H04W 24/04; H04W 28/02

(52) U.S. Cl. CPC H04B 7/15507; H04W 40/248; H04W 24/04; H04W 28/0278

(57) ABSTRACT

In a first aspect, a communication control method is used in a cellular communication system. The communication control method includes performing, by a donor base station including a relay node as a subordinate, configuration whether the relay node causes a scheduler of the relay node to perform priority control in data packet transfer. The communication control method includes causing, by the relay node, the scheduler to operate in accordance with the configuration.

### RELATED APPLICATIONS

The present application is a continuation based on PCT Application No. PCT/JP2022/000640, filed on Jan. 12, 2022, which claims the benefit of US Provisional Patent Application No. 63/136,472 filed on Jan. 12, 2021. The content of which is incorporated by reference herein in their entirety.

### TECHNICAL FIELD

The present disclosure relates to a communication control method used in a cellular communication system.

### BACKGROUND OF INVENTION

In the 3rd generation partnership project (3GPP) that is a project for standardization of cellular communication systems, introducing a new relay node referred to as an integrated access and backhaul (IAB) node (for example, see “3GPP TS 38.300 V16.3.0 (September 2020)”) has been discussed. One or more relay nodes are involved in communication between a base station and user equipment to perform relay for the communication.

### SUMMARY

In a first aspect, a communication control method is used in a cellular communication system. The communication control method includes performing, by a donor base station including a relay node as a subordinate, configuration whether the relay node causes a scheduler of the relay node to perform priority control in data packet transfer. The communication control method includes causing, by the relay node, the scheduler to operate in accordance with the configuration.

In a second aspect, the communication control method is used in a cellular communication system. The communication control method includes transmitting, by a relay node to a donor base station including the relay node as a subordinate, first information indicating throughput of each route, second information indicating the number of discarded data packets, or third information indicating that a failure occurrence notification has been received. The communication control method includes performing, by the donor base station, a predetermined operation based on the first information, the second information, or the third information.

In a third aspect, a communication control method is used in a cellular communication system. The communication control method includes transmitting, by a relay node interposed between a parent node and a child node, a pre-emptive buffer status report to the parent node. The communication control method includes receiving, by the parent node, the pre-emptive buffer status report. The communication control method includes, in the transmitting, storing, by the relay node, a first data amount of first data retained in the child node and a second data amount of second data retained in the relay node in different fields of the pre-emptive buffer status report.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to an embodiment.

FIG. 4 is a diagram illustrating a configuration example of an IAB node (relay node) according to an embodiment.

FIG. 5 is a diagram illustrating a configuration example of user equipment (UE) according to an embodiment.

FIG. 6 is a diagram illustrating an example of a protocol stack relating to an RRC connection and a NAS connection of an IAB-MT.

FIG. 7 is a diagram illustrating an example of a protocol stack relating to an F1-U protocol.

FIG. 8 is a diagram illustrating an example of a protocol stack relating to an F1-C protocol.

FIG. 9 is a diagram illustrating an example of a configuration according to a first embodiment.

FIG. 10 is a diagram illustrating an example of a configuration according to the first embodiment.

FIG. 11 is a flowchart illustrating an operation example according to the first embodiment.

FIG. 12 is a flowchart illustrating an operation example according to the first embodiment.

FIG. 13 is a flowchart illustrating an operation example according to a second embodiment.

FIG. 14 is a flowchart illustrating an operation example according to a third embodiment.

FIG. 15 is a diagram illustrating a transmission example of a failure occurrence notification according to a fourth embodiment.

FIG. 16 is a flowchart illustrating an operation example according to the fourth embodiment.

FIG. 17A is a diagram illustrating a transmission example of a regular BSR, and FIGS. 17B and 17C are diagrams each illustrating a transmission example of a preemptive BSR.

FIG. 18 is a diagram illustrating a configuration example of a pre-emptive BSR MAC CE.

FIG. 19 is a diagram illustrating an example of a relationship between an IAB node, a parent node, and a child node.

FIG. 20 is a flowchart illustrating an operation example according to a fifth embodiment.

FIG. 21 is a flowchart illustrating an operation example according to a sixth embodiment.

FIG. 22 is a diagram illustrating a transmission example of a pre-emptive BSR and a regular BSR.

FIG. 23 is a flowchart illustrating an operation example according to a seventh embodiment.

### DESCRIPTION OF EMBODIMENTS

A cellular communication system according to embodiments will be described with reference to the drawings. In the description of the drawings, the same or similar parts are denoted by the same or similar reference numerals.

Configuration of Cellular Communication System

First, a configuration example of a cellular communication system according to an embodiment will be described. A cellular communication system 1 according to an embodiment is a 5G system of the 3GPP. Specifically, a radio access scheme for the cellular communication system 1 is New Radio (NR) that is a 5G radio access scheme. However, Long Term Evolution (LTE) may be at least partially applied to the cellular communication system. A future cellular communication system such as 6G may also be applied to the cellular communication system 1.

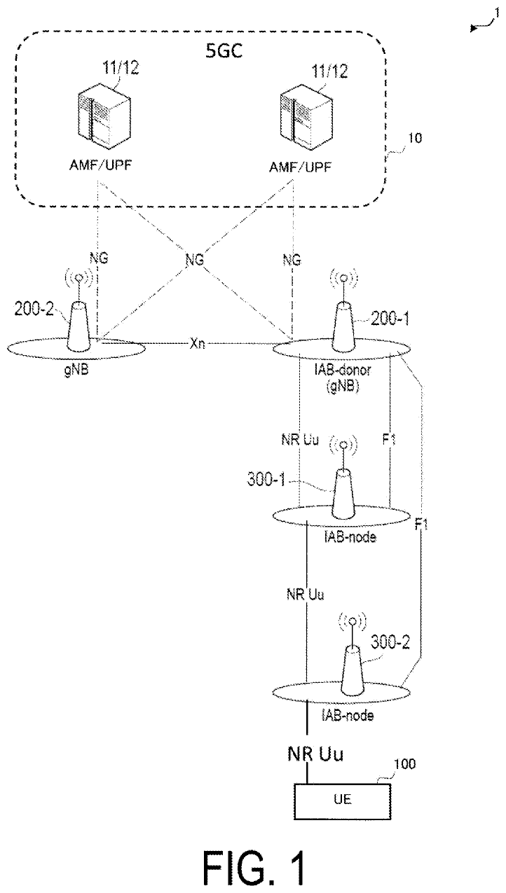

FIG. 1 is a diagram illustrating the configuration example of the cellular communication system 1 according to an embodiment.

The cellular communication system 1 includes a 5G core network (5GC) 10, user equipment (UE) 100, base station apparatuses (hereinafter, also referred to as “base stations”) 200-1 and 200-2, and IAB nodes 300-1 and 300-2 as illustrated in FIG. 1. The base stations 200 may be referred to as gNBs.

Although an example in which the base stations 200 are NR base stations will be mainly described below, the base stations 200 may also be LTE base stations (i.e., eNB s).

Note that the base stations 200-1 and 200-2 may be referred to as gNBs 200 (or base stations 200), and the JAB nodes 300-1 and 300-2 may be referred to as JAB nodes 300 hereinafter.

The 5GC 10 includes an Access and Mobility Management Function (AMF) 11 and a User Plane Function (UPF) 12. The AMF 11 is an apparatus performing various types of mobility control and the like over the UE 100. The AMF 11 communicates with the UE 100 by using Non-Access Stratum (NAS) signaling, and thereby manages information about an area in which the UE 100 exists. The UPF 12 is an apparatus performing control of transfer of user data, and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. Hereinafter, a “cell” may be used without being distinguished from a base station such as the gNB 200. One cell belongs to one carrier frequency.

Each gNB 200 is interconnected to the 5GC 10 via an interface called an NG interface. FIG. 1 illustrates the gNB 200-1 and the gNB 200-2 being connected to the 5GC 10.

Each gNB 200 may be divided into a central unit (CU) and a distributed unit (DU). The CU and the DU are interconnected via an interface called an F1 interface. An F1 protocol is a communication protocol between the CU and the DU and includes an F1-C protocol that is a control plane protocol and an F1-U protocol that is a user plane protocol.

The cellular communication system 1 supports an JAB that uses NR for the backhaul to enable wireless relay of NR access. The donor gNB 200-1 (or IAB donor, which may be referred to as an “IAB donor” below) is a donor base station that is a terminal node of the NR backhaul on the network side and has an additional function of supporting JAB. The backhaul enables multi-hop through a plurality of hops (i.e., a plurality of JAB nodes 300).

FIG. 1 illustrates an example in which the JAB node 300-1 is wirelessly connected to the IAB donor 200-1, the JAB node 300-2 is wirelessly connected to the IAB node 300-1, and the F1 protocol is transmitted in two backhaul hops.

The UE 100 is a mobile wireless communication apparatus performing wireless communication with the cells. The UE 100 may be any type of apparatus as long as the UE 100 is an apparatus performing wireless communication with the gNBs 200 or the IAB nodes 300. For example, the UE 100 is a mobile phone terminal, a tablet terminal, a notebook PC, a sensor or an apparatus provided in a sensor, and/or a vehicle or an apparatus provided in a vehicle. The UE 100 is wirelessly connected to the IAB nodes 300 or the gNBs 200 via an access link. FIG. 1 illustrates an example in which the UE 100 is wirelessly connected to the IAB node 300-2. The UE 100 indirectly communicates with the IAB donor 200-1 via the IAB node 300-2 and the IAB node 300-1.

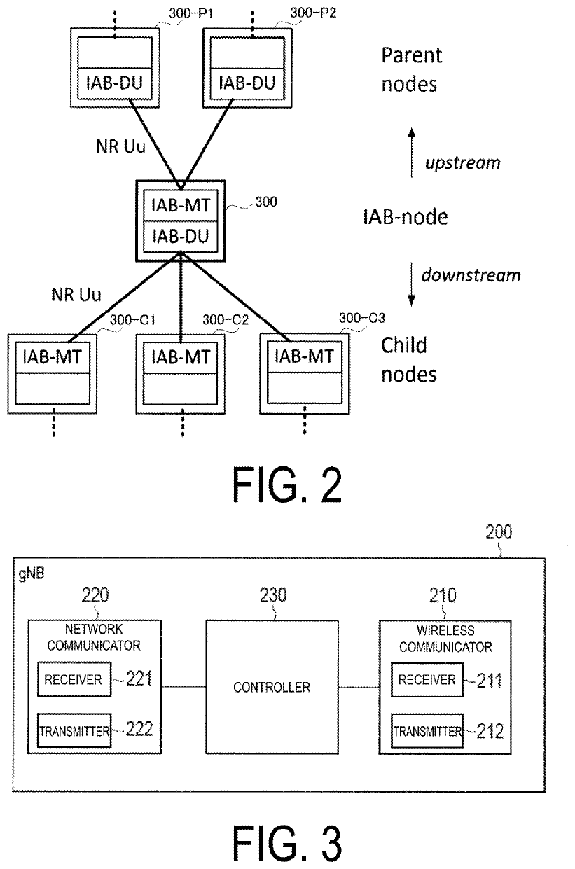

FIG. 2 is a diagram illustrating a relationship between an IAB node 300, parent nodes, and child nodes.

Each IAB node 300 includes an IAB-DU corresponding to a base station function unit and an IAB-mobile termination (MT) corresponding to a user equipment function unit as illustrated in FIG. 2.

A neighboring node (i.e., an upper node) of the IAB-MT on an NR Uu wireless interface is referred to as a “parent node”. Parent nodes are DUs of a parent IAB node or the IAB donor 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. Upper nodes of the UE 100 viewed from the UE 100 may correspond to the parent nodes.

A neighboring node (i.e., a lower node) of the IAB-DU on an NR access interface is referred to as a “child node”. The IAB-DU manages cells the same as, and/or similarly to, the gNBs 200. The IAB-DU terminates the NR Uu wireless interface connected to the UE 100 and the lower IAB nodes. The IAB-DU supports the F1 protocol for the CU of the IAB donor 200-1. Although FIG. 2 illustrates an example in which the child nodes of the IAB node 300 are IAB nodes 300-C1 to 300-C3, the child nodes of the IAB node 300 may include the UE 100. Note that the direction toward the child nodes is referred to as downstream.

All of the IAB nodes 300 connected to the IAB donor 200 via one or more hops form a Directed Acyclic Graph (DAG) topology (which may be referred to as “topology” below) rooted at the IAB donor 200. In this topology, the neighboring nodes of the IAB—DU in the interface are child nodes, and the neighboring nodes of the IAB-MT in the interface are parent nodes as illustrated in FIG. 2. The IAB donor 200 performs, for example, centralized management on resources, topology, and routes of the IAB topology.

Configuration of Base Station

A configuration of the gNB 200 that is a base station according to the embodiment will be described. FIG. 3 is a diagram illustrating a configuration example of the gNB 200. The gNB 200 includes a wireless communicator 210, a network communicator 220, and a controller 230 as illustrated in FIG. 3.

The wireless communicator 210 performs wireless communication with the UE 100 and the IAB nodes 300. The wireless communicator 210 includes a receiver 211 and a transmitter 212. The receiver 211 performs various types of reception under control of the controller 230. The receiver 211 includes an antenna, converts (down-converts) a radio signal received by the antenna into a baseband signal (reception signal), and outputs the signal to the controller 230. The transmitter 212 performs various types of transmission under control of the controller 230. The transmitter 212 includes an antenna, converts (up-converts) the baseband signal (transmission signal) output by the controller 230 into a radio signal, and transmits the signal from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the received signal to the controller 230. The transmitter 222 performs various types of transmission under control of the controller 230. The transmitter 222 transmits a transmission signal output by the controller 230 to an external destination.

The controller 230 performs various types of control for the gNB 200. The controller 230 includes at least one memory and at least one processor electrically connected to the memory. The memory stores a program to be executed by the processor and information to be used for processing by the processor. The processor may include a baseband processor and a central processing unit (CPU). The baseband processor performs modulation and demodulation, coding and decoding, and the like on baseband signals. The CPU executes the program stored in the memory to thereby perform various types of processing. The processor performs processing on each layer to be described below. In each example to be introduced below, the controller 230 may perform each processing operation for the gNB 200.

Configuration of Relay Node

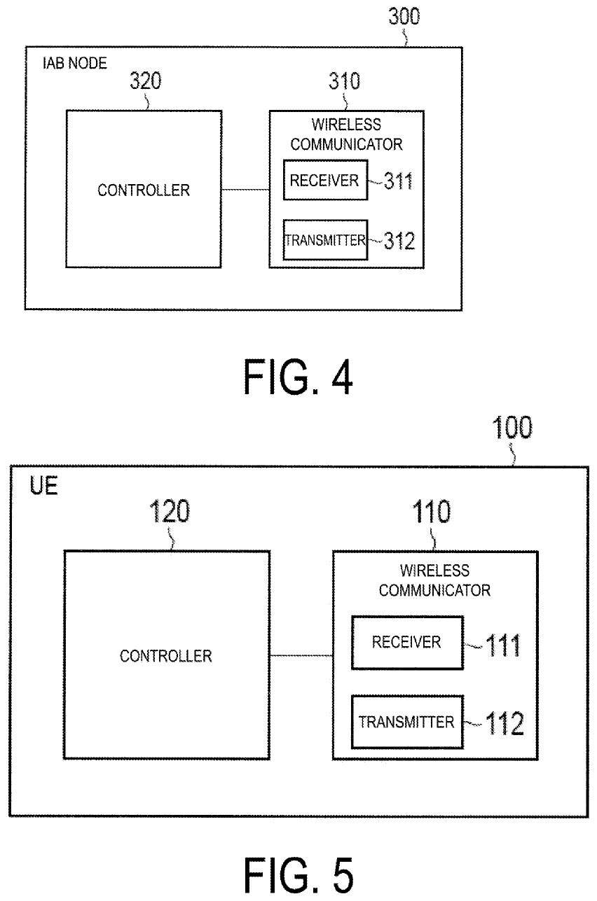

A configuration of the IAB node 300 that is a relay node (or a relay node apparatus, which may also be referred to as a “relay node” below) according to the embodiment is described below. FIG. 4 is a diagram illustrating a configuration example of the IAB node 300. The IAB node 300 includes a wireless communicator 310 and a controller 320 as illustrated in FIG. 4. The IAB node 300 may include a plurality of the wireless communicators 310.

The wireless communicator 310 performs wireless communication with the gNB 200 (BH link) and wireless communication with the UE 100 (access link). A wireless communicator 310 for BH link communication may be provided separately from a wireless communicator 310 for access link communication.

The wireless communicator 310 includes a receiver 311 and a transmitter 312. The receiver 311 performs various types of reception under control of the controller 320. The receiver 311 includes an antenna, converts (down-converts) a radio signal received by the antenna into a baseband signal (reception signal), and outputs the signal to the controller 320. The transmitter 312 performs various types of transmission under control of the controller 320. The transmitter 312 includes an antenna, converts (up-converts) the baseband signal (transmission signal) output by the controller 320 into a radio signal, and transmits the signal from the antenna.

The controller 320 performs various types of control for the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like on baseband signals. The CPU executes the program stored in the memory to thereby perform various types of processing. The processor performs processing on each layer to be described below. In each example described below, the controller 320 may perform each processing operation for the IAB node 300.

Configuration of User Equipment

A configuration of the UE 100 that is user equipment according to the embodiment is described below. FIG. 5 is a diagram illustrating a configuration example of the UE 100. The UE 100 includes a wireless communicator 110 and a controller 120 as illustrated in FIG. 5.

The wireless communicator 110 performs wireless communication in an access link, that is, wireless communication with the gNB 200 and wireless communication with the IAB node 300. The wireless communicator 110 may also perform wireless communication in a sidelink, that is, wireless communication with another piece of UE 100. The wireless communicator 110 includes a receiver 111 and a transmitter 112. The receiver 111 performs various types of reception under control of the controller 120. The receiver 111 includes an antenna, converts (down-converts) a radio signal received by the antenna into a baseband signal (reception signal), and outputs the signal to the controller 120. The transmitter 112 performs various types of transmission under control of the controller 120. The transmitter 112 includes an antenna, converts (up-converts) the baseband signal (transmission signal) output by the controller 120 into a radio signal, and transmits the signal from the antenna.

The controller 120 performs various types of control for the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like on baseband signals. The CPU executes the program stored in the memory to thereby perform various types of processing. The processor performs processing on each layer to be described below. In each example to be described below, the controller 130 may perform each processing operation for the UE 100.

Configuration of Protocol Stack

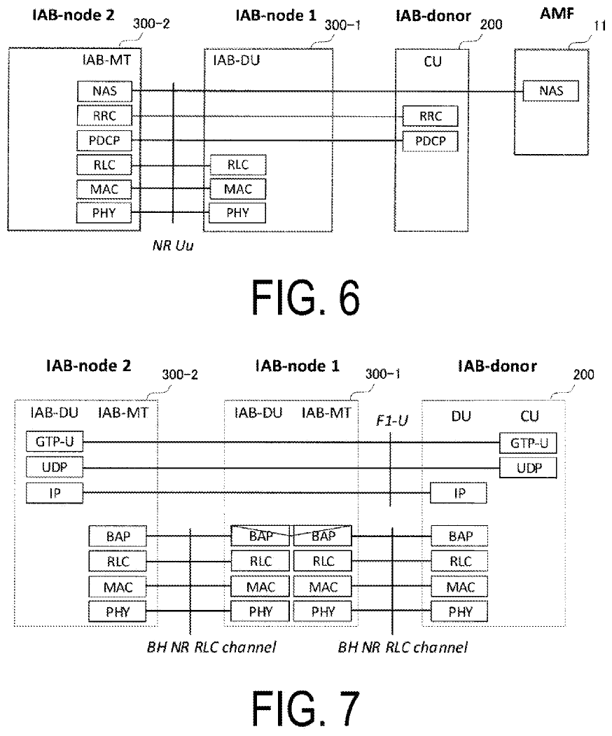

A configuration of a protocol stack according to the embodiment is described below. FIG. 6 is a diagram illustrating an example of a protocol stack relating to an RRC connection and a NAS connection of an IAB-MT.

The IAB-MT of the IAB node 300-2 includes a physical (PHY) layer, a medium access control (MAC) layer, a radio link control (RLC) layer, a packet data convergence protocol (PDCP) layer, a radio resource control (RRC) layer, and a non-access stratum (NAS) layer as illustrated in FIG. 6.

The PHY layer performs coding and decoding, modulation and demodulation, antenna mapping and demapping, and resource mapping and demapping. Data and control information are transmitted via a physical channel between the PHY layer of the IAB-MT of the IAB node 300-2 and the PHY layer of the IAB-DU of the IAB node 300-1.

The MAC layer performs priority control of data, retransmission processing using a hybrid-automatic repeat request (hybrid ARQ or HARQ), a random access procedure, and the like. Data and control information are transmitted via a transport channel between the MAC layer of the IAB-MT of the IAB node 300-2 and the MAC layer of the IAB-DU of the IAB node 300-1. The MAC layer of the IAB-DU includes a scheduler. The scheduler determines a transport format (a transport block size, or a modulation and coding scheme (MCS)) and allocated resource blocks in uplink and downlink.

The RLC layer transmits data to the RLC layer on the reception side by using the functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the IAB donor 200 via a radio bearer.

The RRC layer controls a logical channel, a transport channel, and a physical channel in accordance with establishment, reestablishment, and release of a radio bearer. RRC signaling for various configurations is transmitted between the RRC layer of the IAB-MT of the IAB node 300-2 and the RRC layer of the IAB donor 200. When an RRC connection to the IAB donor 200 is present, the IAB-MT is in an RRC connected state. When no RRC connection to the IAB donor 200 is present, the IAB-MT is in an RRC idle state.

The NAS layer which is positioned higher than the RRC layer performs session management, mobility management, and the like. NAS signaling is transmitted between the NAS layer of the IAB-MT of the JAB node 300-2 and the AMF 11.

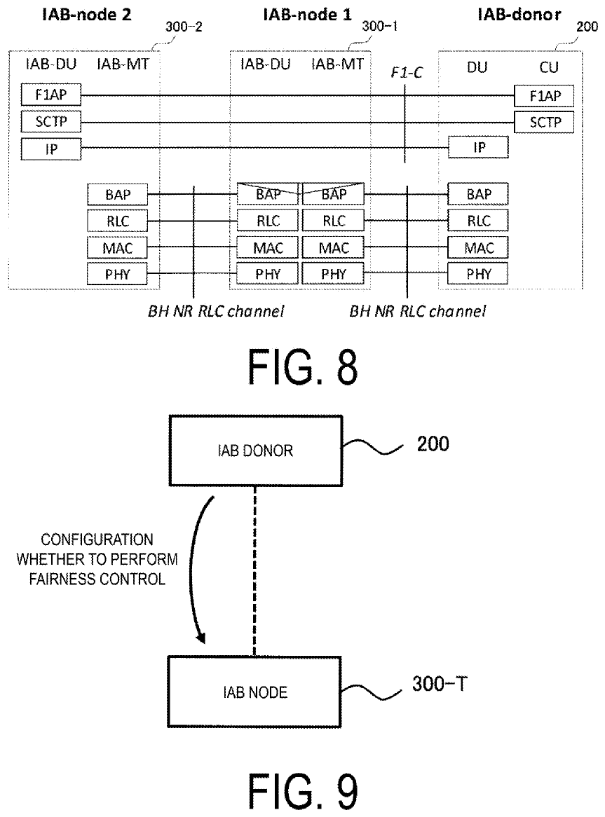

FIG. 7 is a diagram illustrating a protocol stack relating to the F1-U protocol. FIG. 8 is a diagram illustrating a protocol stack relating to the F1-C protocol. An example in which the IAB donor 200 is divided into a CU and a DU is illustrated.

Each of the IAB-MT of the JAB node 300-2, the IAB-DU of the JAB node 300-1, the IAB-MT of the IAB node 300-1, and the DU of the IAB donor 200 includes a backhaul adaptation protocol (BAP) layer as an upper layer of the RLC layer as illustrated in FIG. 7. The BAP layers perform routing processing, and bearer mapping and demapping processing. In a backhaul, an IP layer is transmitted via a BAP layer to allow routing through a plurality of hops.

In each backhaul link, a protocol data unit (PDU) of each BAP layer is transmitted via a backhaul RLC channel (BH NR RLC channel). Each BH link includes a plurality of backhaul RLC channels. This enables prioritization and QoS control of traffic. The BAP layer of each JAB node 300 and the BAP layer of the IAB donor 200 associate a BAP PDU with the backhaul RLC channel.

Note that the CU of the IAB donor 200 terminates the F1 interface with respect to the JAB nodes 300 and the DU of the IAB donor 200, and fulfills the gNB-CU function of the IAB donor 200. The DU of the IAB donor 200 hosts an JAB BAP sublayer, provides a wireless backhaul to the JAB nodes 300, and fulfills the gNB-DU function of the IAB donor 200.

The protocol stack of the F1-C protocol includes an F1AP layer and a stream control transmission protocol (SCTP) layer as illustrated in FIG. 8, instead of the GTP—U layer and the UDP layer illustrated in FIG. 7.

Note that processing or an operation performed by the IAB-DU and the IAB-MT of the JAB may be simply described as processing or an operation of the “JAB” in the description below. For example, transmission of a message by the IAB-DU of the IAB node 300-1 to the IAB-MT of the JAB node 300-2 in the BAP layer will be described as transmission of the message by the IAB node 300-1 to the IAB node 300-2. Processing or an operation of the DU or the CU of the IAB donor 200 may be described simply as processing or an operation of the “IAB donor”.

The upstream direction and the uplink (UL) direction may be used interchangeably. The downstream direction and the downlink (DL) direction may be used interchangeably.

### First Embodiment

With respect to IAB, there is the concept of topology-wide fairness (which may be referred to as “fairness” below). Fairness provides, for example, a mechanism for managing Quality of Service (QoS) to meet the QoS required throughout the topology no matter what part of an IAB network the UE 100 connects to. For example, it can be said that fairness is for managing the entire topology to gain the same QoS whether the UE 100 is connected to the IAB node 300-2 or the IAB donor 200-1 in FIG. 1.

Approaches to such fairness are classified into, for example, the following two categories.
(A1) Local/distributed fairness optimization
(A2) Centralized fairness optimization

For example, the scheduler of each IAB node 300 performs (A1). The IAB node 300 can achieve optimization like (A1) by providing the scheduler with information such as the number of remaining hops.

On the other hand, (A2) is performed by, for example, updating of routing configurations by the IAB donor 200. The IAB node 300 may report information such as a congestion state and/or delay information to the IAB donor 200 to enable the routing configurations to be updated.

While (A1) has an advantage of being able to achieve a higher speed, the advantage is limited to local connections and may vary depending on the implementation of the scheduler. Although (A2) can solve the problem of optimizing the entire topology, it is possible the (A2) cannot solve the problem of fairness on a packet basis.

For this reason, there is also an approach in which (A1) and (A2) are mixed as an approach to fairness. By mixing the two options, the advantages of (A1) and (A2) can be obtained and the disadvantages of (A1) and (A2) can be minimized.

A first embodiment is an example in which the IAB donor 200 instructs the IAB node 300 whether to perform (A1), when mixing the two options in such a way. Specifically, first, a donor base station (for example, the IAB donor 200) including a relay node (for example, the IAB node 300) as a subordinate configures whether the relay node causes a scheduler of the relay node to perform priority control of data packet transfer. Second, the relay node operates the scheduler in accordance with the configuration. In the following description, priority control in data packet transfer may be simply referred to as data packet transfer control.

FIG. 9 is a diagram illustrating an example in which the IAB donor 200 configures whether an IAB node 300-T causes a scheduler of the IAB node 300-T to control data packet transfer. The control of data packet transfer is an example of control related to, for example, fairness. With such a configuration the IAB donor 200 can, for example, instruct the IAB node 300-T whether to perform control related to fairness (hereinafter, may be referred to as “fairness control”). This makes it possible to instruct the above-mentioned (A1) to be performed.

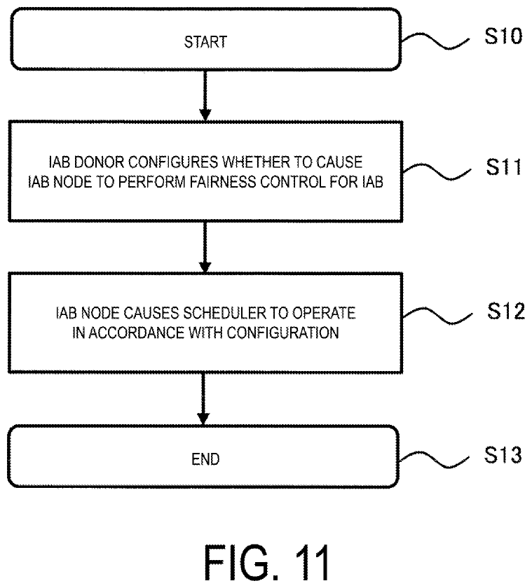

FIG. 11 is a flowchart illustrating an operation example according to the first embodiment.

When the IAB donor 200 starts processing in step S10, the IAB donor 200 configures whether to cause the IAB node 300-T to perform fairness control for the IAB in step S11. Specific examples of fairness control are as follows.
(B1) Priority is given to transfer of a data packet passing a large number of (past) hops. This makes it possible to realize the above-described fairness since a data packet with a long delay is preferentially transferred, for example.
(B2) Priority is given to transfer of a data packet passing a large number of remaining (future) hops. Also in this case, since a data packet with a long delay is preferentially transferred the same as, and/or similarly to, (B1), fairness can be realized.
(B3) Priority is given to transfer of a data packet with a large number of multiplexed UE bearers per BH RLC channel (“N” of 1-to-N mapping). This makes it possible to reduce transfer delay due to large amounts of data and to achieve the above-described fairness since a data packet having a large amount of data is preferentially transferred, for example.
(B4) Priority is given to transfer of a data packet having a longer elapsed period based on a time stamp. This makes it possible to reduce transfer delay and achieve fairness since a data packet having a long elapsed period based on a certain time is preferentially transferred, for example.

Note that the IAB donor 200 may configure the fairness control by combining the above-mentioned (B1) to (B4). The IAB donor 200 may configure the UE bearer ID or the BH RLC channel ID to be excluded from the fairness control for the IAB node 300-T. The IAB donor 200 may transmit an RRC message, an F1-AP message, a MAC CE, or the like to the IAB node 300-T to configure fairness control for the IAB node 300.

In step S12, the IAB node 300-T causes the scheduler to operate in accordance with the configuration. Specifically, the IAB-DU (scheduler) of the IAB node 300-T controls data packet transfer in accordance with the configurations of (B1) to (B4) described above. Details of the control is as follows.

For example, the header of the BAP data PDU includes the number of hops incremented each time the BAP data PDU passes through the IAB node 300. When the above-mentioned (B1) is configured, the scheduler transfers a data packet passing through a large number of hops with priority, based on the number of hops.

For example, the number of hops up until a target is included in the header of the BAP data PDU, and the number of hops is decremented each time the BAP data PDU passes through the IAB node 300. When the above-mentioned (B2) is configured, the scheduler transfers a data packet passing through a large number of remaining hops with priority, based on the number of hops.

When the above-mentioned (B3) is configured, the scheduler checks the number of multiplexed bearers of each piece of UE 100 on each BH RLC channel, and transfers a data packet having a large number of multiplexed bearers with priority.

When the above-mentioned (B4) is configured, the scheduler transfers a data packet having a long elapsed period with priority based on the time stamp value included in the header of the BAP data PDU.

In step S13, the IAB node 300 ends the series of processing operations.

Although an example of fairness control (priority control) by the scheduler has been described in the above-described embodiment, the present invention is not limited thereto. Fairness control may also be implemented in routing processing. To be more specific, in the BAP layer, routing processing of a packet to be prioritized (for example, a packet passing through a large number of remaining hops) is prioritized. In other words, the BAP layer passes (or transfers) a prioritized packet to a lower layer (for example, the RLC layer) prior to (or earlier than) other packets. In this case, it needs be noted that the IAB donor 200 can configure fairness control for the IAB node 300 and the IAB node 300 can perform routing processing according to the configuration the same as, and/or similar to, the above-described embodiment.

Another example according to the first embodiment will be described.

In another example of the first embodiment, first, a donor base station (for example, the IAB donor 200) configures whether to cause a relay node (for example, the IAB node 300) to notify the parent node or the child node of assist information. The assist information is information for performing control of data packet transfer by the scheduler of the parent node or the child node of the relay node. Second, the relay node notifies the parent node or the child node of the assist information in accordance with the configuration.

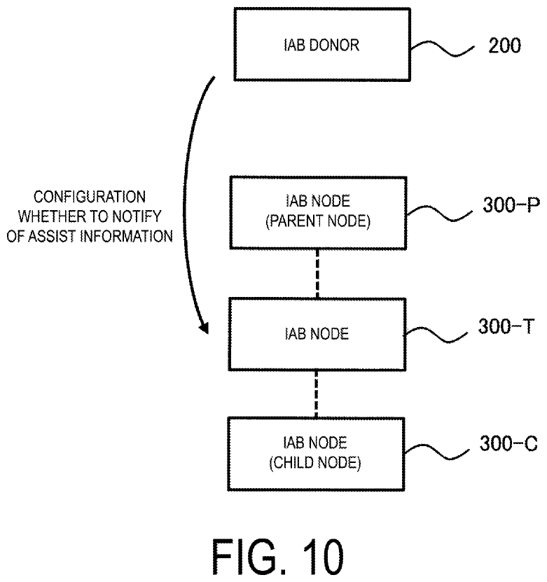

FIG. 10 is a diagram illustrating an example in which the IAB donor 200 configures whether the IAB node 300-T notifies of assist information. Such a configuration allows a parent node 300-P or a child node 300-C of the IAB node 300-T to perform fairness control based on the assist information. As a result, the IAB donor 200 can (indirectly) instruct (the scheduler of) the parent node 300-P or the child node 300-C of the IAB node 300-T to perform the above-mentioned (A1) in accordance with the configuration.

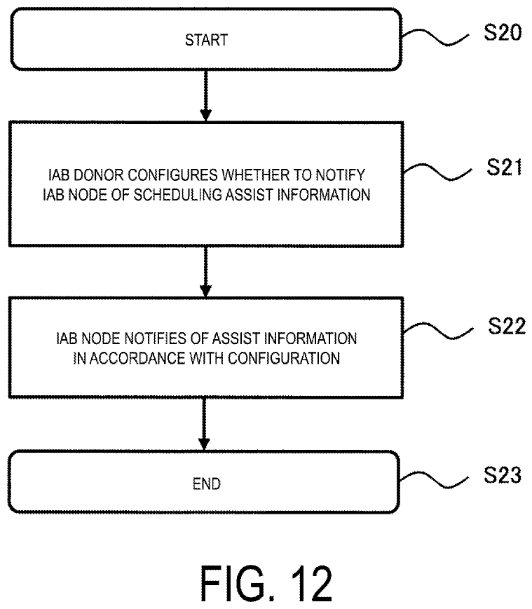

FIG. 12 is a flowchart illustrating an operation example according to another example of the first embodiment.

When the IAB donor 200 starts processing in step S20, the IAB donor configures whether the IAB node 300-T notifies the parent node 300-P or the child node 300-C of the IAB node 300-T of scheduling assist information in step S21. This configuration is performed by using an RRC message, an F1-AP message, or the like.

Note that the assist information is information included in the header of a BAP data PDU and may be information that is changed each time the assist information passes through the IAB node 300. Examples of such information include a count value of the number of hops or a time stamp value for measuring transfer latency. The assist information may be congestion information such as a flow control feedback message. The flow control feedback message is, for example, a message used to notify the parent node 300-P or the child node 300-C of congestion occurring when the IAB node 300-T is congested.

In step S22, the IAB node 300-T notifies the parent node 300-P or the child node 300-C of the assist information in accordance with the configuration. The scheduler of the parent node 300-P or the child node 300-C performs fairness control (for example, all or some of (B1) to (B4)) based on the assist information.

In step S23, the IAB node 300-T ends the series of processing operations.

Although an example in which the assist information is provided from the IAB node 300-T to the parent node 300-P or the child node 300-C has been introduced in the other example of the first embodiment, the present invention is not limited thereto. The assist information may be provided from the IAB donor 200 to the IAB node 300-T, and the IAB node 300-T that has been provided with the assist information may perform fairness control. In this case, the assist information may be the number of remaining hops, the number of UE bearers, priority information (for example, QoS configuration information), transfer delay information (for example, measured average latency in a certain period of time), and/or congestion degree information (for example, a use rate or a margin of radio resources or a load) for each BH RLF channel or each routing ID. Assist information aggregated by the IAB donor 200 may be used as the assist information in a second embodiment.

### Second Embodiment

For fairness, information of the IAB node 300 is preferably aggregated to the IAB donor 200 as much as possible when the approach according to (A2) described in the first embodiment is adopted. This is because the IAB donor 200 knows topology-wide fairness and thus the IAB donor 200 has a main role in achieving fairness.

In the second embodiment, first, a relay node (for example, the IAB node 300) transmits first information indicating a throughput of each route to a donor base station (for example, the IAB donor 200) having the relay node as a subordinate. Second, the donor base station performs a predetermined operation based on the first information. The IAB donor 200 updates routing configurations as the predetermined operation. As a result, for example, the IAB donor 200 can achieve fairness based on the approach (A2) by updating the routing configurations.

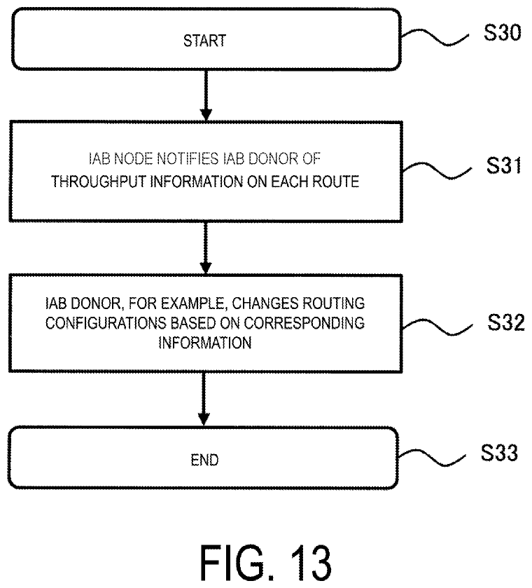

FIG. 13 is a flowchart illustrating an operation example according to the second embodiment.

When the processing is started in step S30, the IAB node 300 notifies the IAB donor 200 of throughput information on each route in step S31.

For the DL direction, the link state of the BH link between the IAB node 300 and the child node thereof or the access link between the IAB node 300 and the UE 100 is represented as throughput. In this case, the IAB node 300 may report the throughput. On the other hand, for the UL direction, the link state of the BH link between the IAB node 300 and the parent node thereof is represented as throughput. In this case, the parent node may report the throughput.

The throughput information may be represented by maximum throughput and/or minimum throughput of the BH link or the access link. The throughput information may be a theoretical value and/or an actual value. The throughput information may be average throughput over a certain period of time. The IAB donor 200 may configure the certain period of time (for example, the past 10 seconds). Note that the throughput information may be the throughput of each path, instead of the throughput information on each route.

Note that reporting of the throughput information by the IAB node 300 as in step S31 enables the IAB node 300 to report accurate throughput to the IAB donor 200 in accordance with the implementability of the scheduler of the IAB node 300 or the load state of the scheduler.

In step S32, the IAB donor 200 updates the routing configurations and the like based on the throughput information.

In step S33, the IAB donor 200 ends the series of processing operations.

### Third Embodiment

One of the QoS characteristics of 5G is a packet delay budget (PDB). A PDB represents an upper time limit by which a packet is delayed between the UE 100 and the UPF 12. Packets that are delayed beyond the PDB may be discarded in response to a locally made determination. By configuring a PDB, it is possible to avoid having to process an unexpected value in the scheduler.

Since discarding of packets based on the PDB is performed locally as described above, the IAB donor 200 is not able to detect the discarded packets.

For this reason, upon discarding packets, the IAB node 300 reports the number of discarded packets to the IAB donor 200 in a third embodiment. Specifically, first, a relay node (for example, the IAB node 300) transmits second information indicating the number of discarded data packets to a donor base station (for example, the IAB donor 200) having the relay node as a subordinate. Second, the donor base station performs a predetermined operation based on the second information. As a result, for example, the IAB donor 200 detects the packets discarded by the IAB node 300 and updates the routing configurations, and thereby makes it possible to achieve fairness based on the approach of the above-mentioned (A2).

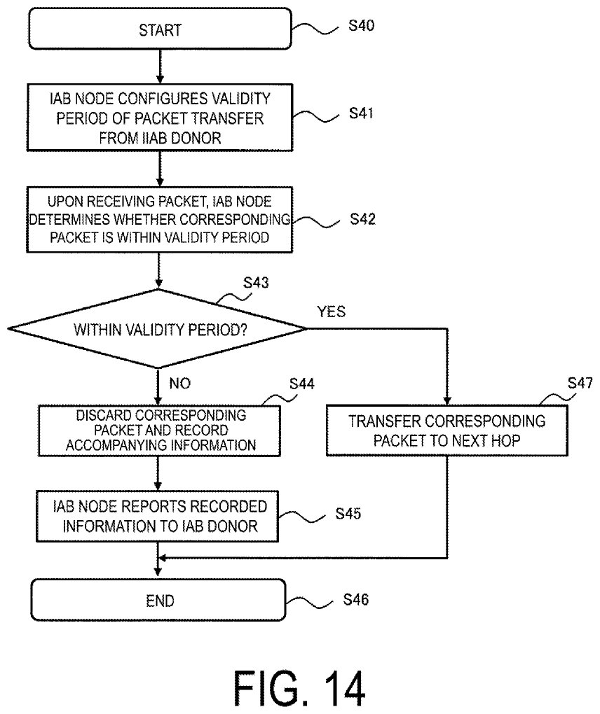

FIG. 14 is a flowchart illustrating an operation example according to the third embodiment.

When the IAB node 300 starts processing in step S40, the IAB donor 200 configures a validity period of packet transfer in step S41. This configuration is made using, for example, an RRC message and/or an F1-AP message.

In step S42, when the IAB node 300 receives a data packet, the IAB node 300 determines whether the data packet is within the validity period. For example, the IAB node 300 calculates the delay time of the data packet based on time stamp information included in the header of the BAP data PDU and compares the calculated delay time with the configured validity period. The IAB node 300 thereby determines whether the delay time is within the validity period. When the time stamp information is expressed as time information on when the source transmits the data packet, the IAB node 300 may compare the current time with the time stamp information to calculate the delay time.

When the data packet is not within the validity period in step S43 (NO in step S43), the IAB node 300 discards the data packet in step S44. At this time, the IAB node 300 counts the number of discarded data packets and stores the count value and accompanying information as recorded information in a memory or the like. The accompanying information includes, for example, an ingress BH RLC channel ID, a routing ID (or a destination ID or a path ID), and/or a delay time (a delay at the time when the data packet was received).

In step S45, the IAB node 300 reports the recorded information to the IAB donor 200. For example, the IAB node 300 reports the recorded information when the number of discarded packets reaches or exceeds a certain value (within a certain period of time). Alternatively, the IAB node 300 may report the recorded information at regular intervals. Alternatively, the IAB node 300 may report the recorded information when there is a request from the IAB donor 200. The IAB node 300 may report the recorded information to the IAB donor 200 using a BAP message or the like.

In step S46, the IAB node 300 ends the series of processing operations. The IAB donor 200, for example, updates the routing configurations as a predetermined operation based on the recorded information.

On the other hand, if the data packet is within the validity period in step S43 (YES in step S43), the IAB node 300 transfers the received data packet to the next hop.

Then in step S46, the IAB node 300 ends the series of processing operations.

### Fourth Embodiment

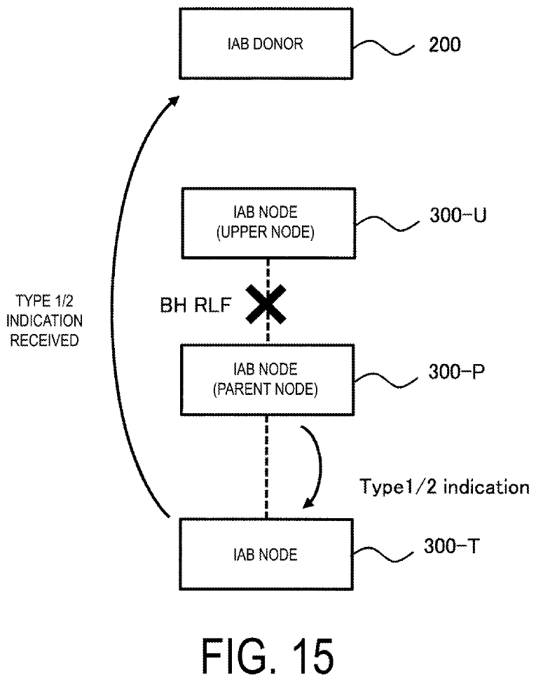

FIG. 15 is a diagram illustrating an example in which the IAB node 300 transmits a failure occurrence notification message to the IAB donor 200.

It is assumed that a backhaul radio link failure (radio link failure in the BH link or BH RLF) has occurred in the BH link between the parent node 300-P of the IAB node 300 and an upper node 300-U which is the parent node of the parent node 300-P as illustrated in FIG. 15. In this case, the parent node 300-P sends to the IAB node 300-T a failure occurrence notification indicating that the BH RLF has occurred.

However, the failure occurrence notification is sent from the parent node 300-P to the IAB node 300-T but is not sent to the IAB donor 200. For this reason, the IAB donor 200 cannot detect that the BH RLF has occurred at the parent node 300-P. When the IAB donor 200 cannot detect the BH RLF at the parent node 300-P, performance of the entire topology may decrease (for example, be congested or delayed).

Here, upon receiving the failure occurrence notification, the IAB node 300 reports the received notification to the IAB donor 200 in a fourth embodiment. Specifically, first, a relay node (for example, the IAB node 300) transmits third information indicating that a failure occurrence notification has been received to a donor base station (for example, the IAB donor 200) having the relay node as a subordinate. Second, the donor base station performs a predetermined operation based on the third information. As the predetermined operation, for example, the IAB donor 200 updates the routing configurations. As a result, for example, a decrease in the performance of the entire topology can be avoided. For example, information can be aggregated to the IAB donor 200 to achieve fairness based on the approach of the above-described (A2).

The failure occurrence notification includes a BH RLF Type 1 indication (RLF detected). The Type 1 indication is an indication to notify the IAB node 300-T (or the UE 100) of the BH RLF when the IAB-DU of the parent node 300-P detects the BH RLF. The failure occurrence notification includes a Type 2 indication of the BH RLF (trying to recover). The Type 2 indication is an indication to notify the IAB-MT of the IAB node 300-T (or the UE 100) of the BH RLF when the IAB-DU of the parent node 300-P detects an operation to recover from the BH RLF. When the Type 1 indication and the Type 2 indication are not distinguished from each other, the IAB-DU of the parent node 300-P can notify the IAB-MT of the IAB node 300-T (or the UE 100) of the Type 1/2 indication. The Type 1/2 indication is an example of the failure occurrence notification.

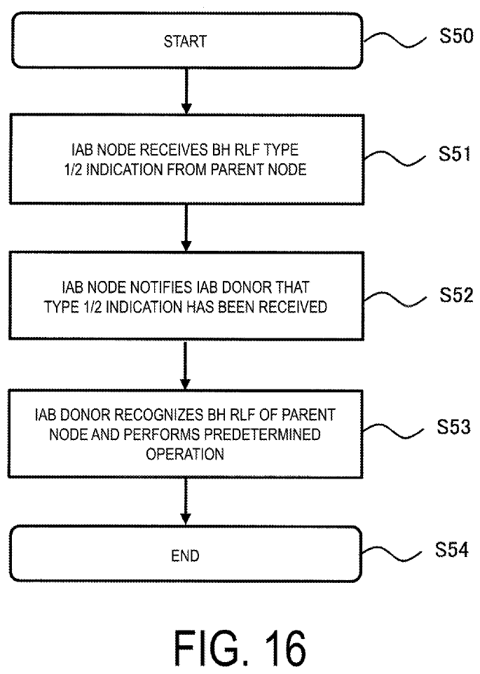

FIG. 16 is a flowchart illustrating an operation example according to the fourth embodiment. Note that in the following description, although the Type 1/2 indication will be described as an example of the failure occurrence notification, the failure occurrence notification may be the Type 1 indication or the Type 2 indication.

When the IAB node 300-T starts processing in step S50, the IAB node 300-T receives the BH RLF Type 1/2 indication from the parent node 300-P in step S51.

In step S52, the IAB node 300-T notifies the IAB donor 200 that the Type 1/2 indication has been received. The notification may include the cell ID of the parent node 300-P, the gNB ID of the parent node 300-P, and/or the BAP address of the parent node 300-P.

Examples of the IAB node 300-T being connected to the parent node 300-P and another parent node through dual connectivity (DC) as this notification transmission path includes the following cases. That is, when the IAB node 300-T receives the Type 1/2 indication via a master cell group (MCG), the IAB node 300-T may transmit the notification via a secondary cell group (SCG) (signaling radio bearer (SRB) 3). Alternatively, upon receiving the Type 1/2 indication via the SCG, the IAB node 300-T may transmit the notification via the MCG (SRB1). Alternatively, the IAB node 300-T may transmit the notification via a split SRB1.

In step S53, the IAB donor 200 recognizes that the BH RLF has occurred at the parent node 300-P in response to the reception of the Type 1/2 indication and performs a predetermined operation. The predetermined operation includes updating the routing configurations, instructing local rerouting to the IAB node 300-T, and handover to the IAB node 300-T.

In step S54, the IAB node 300 ends the series of processing operations.

In the above-described operation example, the Type 1/2 indication may be replaced with a Type 3 indication, a Type 4 indication, or a flow control feedback message.

The Type 3 indication (RLF recovered) is a recovery-from-failure notification that is transmitted to the IAB node 300-T when the parent node 300-P has recovered from the BH RLF. The Type 4 indication (recovery failure) is an example of a recovery failure notification that is transmitted to the IAB node 300-T when the parent node 300-P has failed to recover from the BH RLF. The recovery-from-failure notification and the recovery failure notification are, for example, notifications relating to radio link failure in the BH link.

The flow control feedback message is, for example, a message that is notified from the parent node 300-P when data packets are congested at the parent node 300-P.

### Fifth Embodiment

Regarding scheduling in the UL direction, a pre-emptive buffer status report (BSR which may be referred to as a “pre-emptive BSR” below) may be used. Here, the pre-emptive BSR will be described.

Pre-Emptive BSR

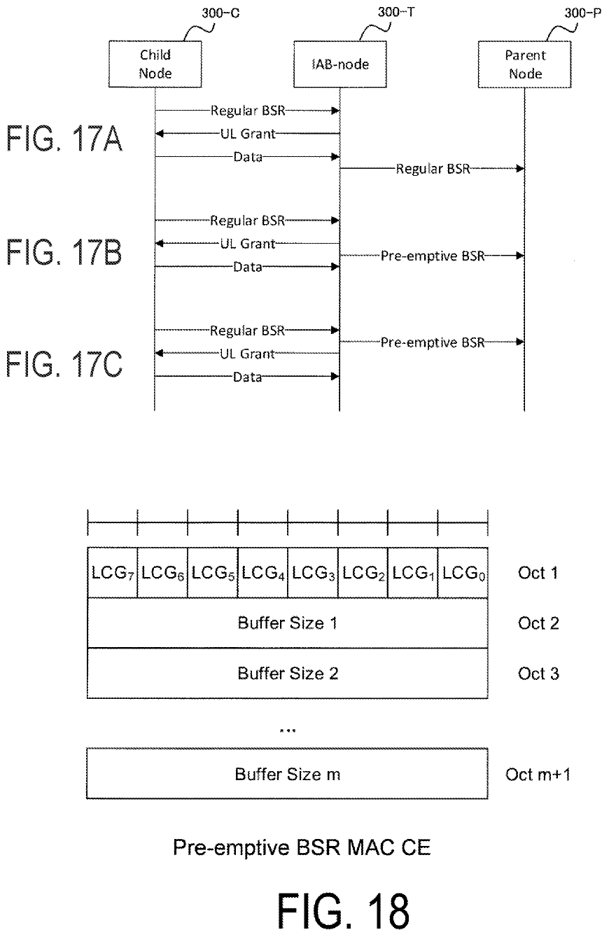

FIG. 17A is a diagram illustrating a transmission example of a regular BSR, and FIGS. 17B and 17C are diagrams illustrating transmission examples of a pre-emptive BSR.

After receiving data from the child node 300-C, the IAB node 300-T transmits a regular BSR to the parent node 300-P as illustrated in FIG. 17A. The parent node 300-P performs scheduling for the IAB node 300-T based on the BSR, and transmits a UL grant to the IAB node 300-T.

On the other hand, after transmitting a UL grant to the child node 300-C, the IAB node 300-T transmits a pre-emptive BSR to the parent node 300-P before receiving data from the child node 300-C as illustrated in FIG. 17B.

After receiving a BSR from the child node 300-C, the IAB node 300-T transmits a pre-emptive BSR to the parent node 300-P before transmitting a UL grant to the child node 300-C as illustrated in FIG. 17C.

Since the pre-emptive BSR is transmitted to the parent node 300-P before the regular BSR as described above, a delay in the UL scheduling of the IAB node 300-T can be reduced.

The pre-emptive BSR is transmitted using an MAC CE the same, and/or similarly to, the regular BSR. FIG. 18 is a diagram illustrating a configuration example of a pre-emptive BSR MAC CE (hereinafter, may be referred to as “pre-emptive BSR”). The pre-emptive BSR MAC CE includes LCGᵢ and buffer size fields as illustrated in FIG. 18.

LCGᵢ is a field indicating that a buffer size of a logical channel group (LCG) i exists. That is, “1” configured for a LCGᵢ indicates that the buffer size of the logical channel group (LCG) i will be reported. On the other hand, “0” configured for a LCGᵢ indicates that the buffer size of the logical channel group i will not be reported.

The buffer size identifies the total amount of data expected to reach the IAB-MT of the IAB node 300 that has triggered the pre-emptive BSR and does not include the total amount of data currently available at the IAB-MT. The buffer size will be described in detail below.

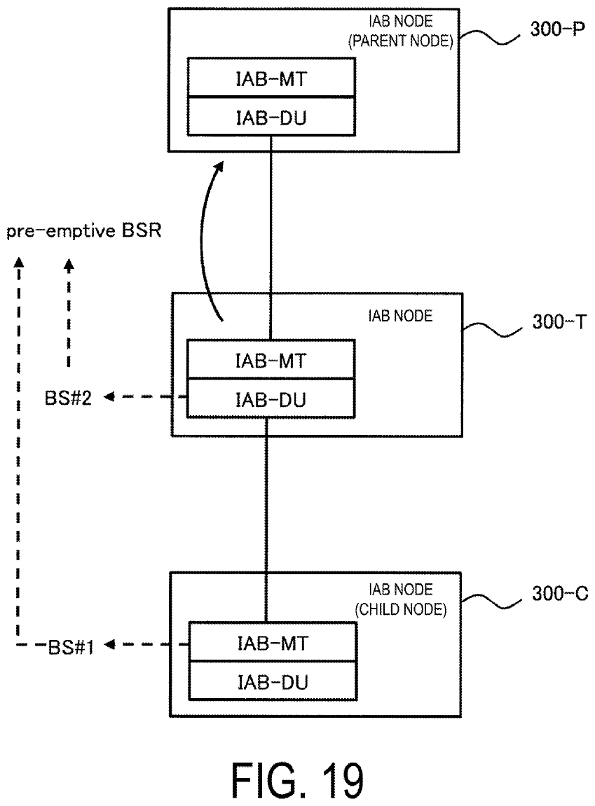

FIG. 19 is a diagram illustrating an example of a relationship between the IAB node 300, the parent node 300-P, and the child node 300-C. FIG. 19 illustrates an example in which the IAB node 300-T transmits a pre-emptive BSR to the parent node 300-P. In the example of FIG. 19, the total amount of data expected to reach the IAB-MT of the parent node 300-P that has triggered the pre-emptive BSR is stored in the buffer size field. The data expected to reach the IAB-MT of the parent node 300-P is the total amount of the data retained in the IAB-DU of the IAB node 300-T and the data retained in the IAB-MT of the child node 300-C. In other words, the buffer size stored in the buffer size field of the pre-emptive BSR is the data amount of the data retained in the IAB-DU of the IAB node 300-T mixed with the data retained in the IAB-MT of the child node 300-C.

However, the scheduling timing of the data retained in the IAB-DU of the IAB node 300-T is different from the scheduling timing of the data retained in the IAB-MT of the child node 300-C. For this reason, even if the parent node 300-P receives the pre-emptive BSR, it may not be sure at which timing scheduling needs be performed for the two pieces of data having different scheduling timings.

The IAB node 300-T stores the amount of data retained in the IAB-DU thereof and the amount of data retained in the IAB-MT of the child node 300-C in different buffer size fields of the pre-emptive BSR in a fifth embodiment. The IAB node 300-T transmits the pre-emptive BSR to the parent node 300-P.

Specifically, first, a relay node (for example, the IAB node 300) interposed between a parent node (for example, the parent node 300-P) and a child node (for example, the child node 300-C) transmits a pre-emptive buffer status report (pre-emptive BSR) to the parent node. At this time, the relay node stores a first data amount of first data retained in the child node in a first buffer size field of the pre-emptive BSR. The relay node stores a second data amount of second data retained in the relay node in a second buffer size field of the pre-emptive BSR. Second, the parent node receives the pre-emptive BSR. As a result, the parent node 300-P can receive the pre-emptive BSR in which the first data amount and the second data amount are stored in different fields, for example, and thus scheduling for the first data and scheduling for the second data can be performed at different timings.

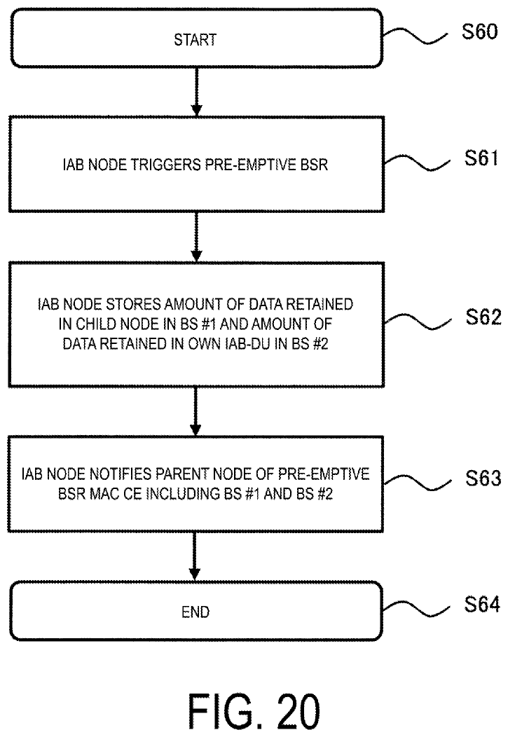

FIG. 20 is a diagram illustrating an operation example of the fifth embodiment.

When the IAB node 300-T starts processing in step S60, the IAB node 300-T triggers a pre-emptive BSR in step S61.

In Step S62, the IAB node 300-T stores the amount of data retained in the IAB-MT of the child node 300-C in the field of a buffer size (BS) #1 of the pre-emptive BSR MAC CE, and stores the amount of data retained in (the IAB-DU of) the IAB node 300-T in the field of a BS #2. At this time, the IAB node 300-T specifies the amount of data retained in the child node 300-C. The specifying may be performed using the buffer size included in the BSR received from the child node 300-C or using the UL grant value scheduled for the child node 300-C by the IAB node 300-T. The IAB node 300-T also specifies the amount of data retained in the IAB-DU thereof. For example, the specifying is performed using the data amount of a reception-side MAC SDU, a reception-side RLC PDU, and/or a reception-side BAP PDU (which may include a transmission-side BAP PDU) retained in the IAB node 300-T. BS #1 and BS #2 are different buffer size fields in the MAC CE.

In step S63, the IAB node 300-T transmits a pre-emptive BSR MAC CE including the BS #1 and the BS #2 to the parent node 300-P.

In step S64, the IAB node 300-T ends the series of processing operations.

Although an example has been described in which one pre-emptive BSR MAC

CE includes the BS #1 and the BS #2 in step S63, different pre-emptive BSR MAC CEs may include the BS #1 and the BS #2. In this case, the IAB node 300-T transmits a pre-emptive BSR MAC CE including the BS #1 and a pre-emptive BSR MAC CE including the BS #2.

The pre-emptive BSR MAC CE illustrated in FIG. 18 is an example. For example, the pre-emptive BSR MAC CE may be a pre-emptive BSR MAC CE of any configuration as long as it is a MAC CE including buffer size fields.

### Sixth Embodiment

A sixth embodiment is an example in which the amount of data retained in the IAB-DU of the IAB node 300-T and the amount of data retained in the IAB-MT of the child node 300-C are distinguished from each other using a LCGᵢ of the pre-emptive BSR.

Specifically, first, a donor base station (for example, the IAB donor 200) including a relay node (for example, the IAB node 300-T) as a subordinate configures a first logical channel group for the relay node. Second, the relay node stores the first data amount of the first data retained in the child node of the relay node in a third buffer size field of a pre-emptive buffer status report, which is a buffer size field corresponding to a first logical channel group.

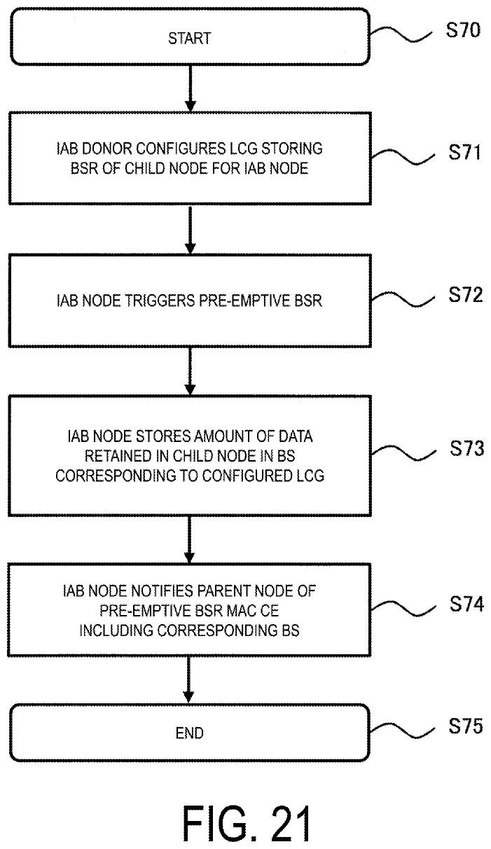

FIG. 21 is a flowchart showing an operation example according to the sixth embodiment.

In step S70, the IAB donor 200 starts processing.

In step S71, the IAB donor 200 configures an LCG for storing the BSR value (or buffer size value) of the child node 300-C for the IAB node 300-T. This configuration is performed using, for example, an RRC message and/or an F1-AP message. For example, the IAB donor 200 configures an LCG₀ (FIG. 18) as the LCG in which the BSR value of the child node 300-C is stored.

In step S72, the IAB node 300-T triggers a pre-emptive BSR.

In step S73, the IAB node 300-T stores the amount of data retained in the IAB-MT of the child node 300-C in the BS (for example, the BS #1) corresponding to the configured LCG (for example, the LCG₀). The IAB node 300-T may specify the data retained in the child node 300-C based on the BSR from the child node 300-C or the UL grant value with respect to the child node 300-C the same as, and/or similarly to, the fifth embodiment.

In step S74, the IAB node 300-T transmits a pre-emptive BSR MAC CE including the BS to the parent node 300-P.

In step S75, the IAB node 300-T ends the series of processing operations.

Note that in the above-described operation example, the amount of data retained in the child node 300-C is transmitted. The amount of data retained in the IAB-DU of the IAB node 300-T is transmitted as follows, for example.

That is, the data retained in the IAB-DU of the IAB node 300-T is the data that the IAB node 300-T has already received from the child node 300-C. The IAB node 300-T compares the data with the configured routing information to recognize which logical channel is to be used to transmit the data. The IAB node 300-T may then specify the LCG (for example, an LCG₁) corresponding to the logical channel and store the data retained in the IAB-DU of the IAB node 300-T in the BS (for example, the BS #2) corresponding to the LCG.

The above-described processing is performed, for example, in step S73 of the operation example illustrated in FIG. 21. That is, the IAB node 300-T stores the amount of data retained in the IAB-MT of the child node 300-C in the BS (for example, the BS #1) corresponding to the LCG configured by the IAB donor 200. The IAB node 300-T stores the amount of the data retained in the IAB-DU thereof in the BS (for example, the BS #2) corresponding to the LCG specified using the routing information.

Note that the amount of the data retained in the child node 300-C may be stored in a BS (for example, BS #3) corresponding to an LCG other than the LCG specified using the routing information, instead of the configuration of the LCG by the IAB donor 200. That is, the IAB node 300 stores the amount of the data retained in the IAB-DU of the IAB node 300-T in the BS (for example, the BS #2) corresponding to the LCG (for example, the LCG₁) specified using the routing information. On the other hand, the IAB node 300 stores the amount of the data retained in the IAB-MT of the child node 300-C in a BS (for example, the BS #3) corresponding to an LCG (for example, an LCG₂) other than the LCG. Therefore, the IAB node 300-T can reliably store the amounts of the two kinds of data in different buffer size fields in the pre-emptive BSR MAC CE and transmit the amounts of data.

### Seventh Embodiment

A seventh embodiment is an example in which the IAB node 300-T reports the amount of data retained in the child node 300-C using a pre-emptive BSR and reports the amount of data retained in the IAB node 300-T using a regular BSR.

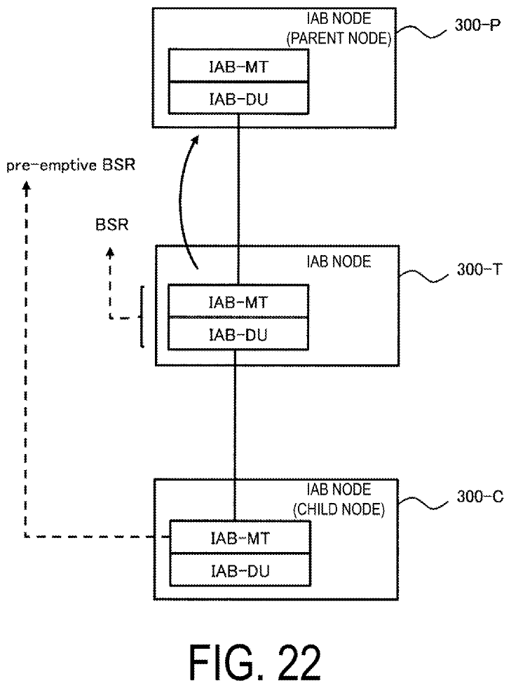

FIG. 22 is a diagram illustrating an example in which the IAB node 300 transmits a pre-emptive BSR and a regular BSR to the parent node 300-P.

The regular BSR currently reports only the amount of data retained in the IAB-MT. However, since the data retained in the IAB-DU of the IAB node 300-T can also be transmitted immediately, it is better to transmit the data using a regular BSR rather than a pre-emptive BSR.

Here, the IAB node 300-T reports the amount of data retained in the IAB-MT and the IAB-DU thereof using a BSR in the seventh embodiment. The IAB node 300-T reports the amount of data retained in the IAB-MT of the child node 300-C using a pre-emptive BSR.

Specifically, a relay node (for example, the IAB node 300-T) transmits a first data amount of first data retained in a child node (for example, the child node 300-C) to a parent node (for example, the parent node 300-P) by using a pre-emptive BSR. The relay node uses a buffer status report to transmit a second data amount of second data retained in the relay node.

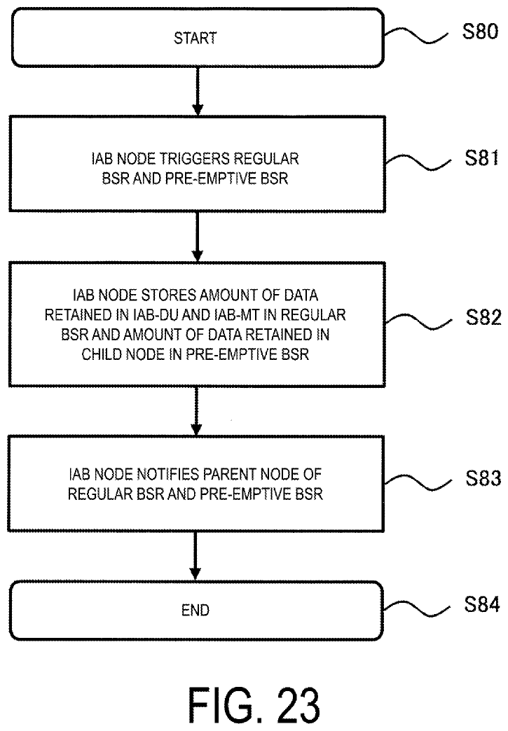

FIG. 23 is a flowchart showing an operation example according to the seventh embodiment.

The IAB node 300-T starts processing in step S80 as illustrated in FIG. 23.

In step S81, the IAB node 300-T triggers a regular BSR and a pre-emptive BSR.

In step S82, the IAB node 300-T identifies the data retained in the IAB-DU and the IAB-MT thereof and stores the data in the BS of the regular BSR MAC CE. The IAB node 300-T identifies the amount of data retained in the IAB-DU thereof based on, for example, BAP PDUs of the transmission and reception sides, an RLC PDU of the reception side, and/or an MAC SDU of the reception side. The IAB node 300-T specifies the amount of data retained in the IAB-MT thereof based on, for example, the MAC SDU of the transmission side and/or the RLC PDU of the transmission side.

In step S82, the IAB node 300-T stores the amount of data retained in the IAB-MT of the child node 300-C in the BS of the pre-emptive BSR MAC CE. The amount of data retained in the child node 300-C is specified, for example, the same as, and/or similarly to, the fifth embodiment.

In step S83, the IAB node 300-T transmits a regular BSR MAC CE and a pre-emptive BSR MAC CE to the parent node 300-P.

In step S84, the IAB node 300-T ends the series of processing operations.

According to this operation example, the buffer size of the pre-emptive BSR MAC CE prescribed in 3GPP TS38.321 is changed from “the total amount of data expected to reach the IAB-MT of the node that has triggered the pre-emptive BSR” to “the total amount of data expected to reach the IAB-DU of the node that has triggered the pre-emptive BSR.”

Note that the IAB node 300-T may transmit the pre-emptive BSR MAC CE and the BSR MAC CE at different timings in the operation example in FIG. 23.

### Other Embodiments

A program causing a computer to execute each of the processing operations performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each of processing operations performed by the UE 100, the gNB 200, or the IAB node 300 may be integrated, and at least some of the UE 100, the gNB 200, and the IAB node 300 may be configured as a semiconductor integrated circuit (a chipset or an SoC).

Although embodiments have been described above in detail with reference to the drawings, a specific configuration is not limited to those described above, and various design modifications and the like can be made without departing from the scope of the present invention. All of or a part of the examples can be combined together as long as the combinations remain consistent.

Supplementary Note

### Introduction

Revised work items related to NR Enhancements to Integrated Access and Backhaul (NR eIAB) have been approved. Some of the purposes thereof are as follows.

Enhancement in Topology Adaptation
Specification of procedures for inter-donor IAB-node migration to enhance robustness and load-balancing, including functional expansion for reducing signaling loads.
Specification of functional expansion for reducing service interruption caused by IAB-node migration and recovery from BH RLF.
Specification of expansion for topology redundancy, including support for CP/UP separation.

Functional expansion of topology, routing, and transport.
Specification of expanded functions for enhancing topology-wide fairness, multi-hop latency, and congestion mitigation.

The following agreement on functional expansion of topology, routing, and transport has been reached.
R2 assumes that the work of Rel-17 IAB does not define new end-user QoS metrics in addition to the existing 5G QoS framework.
The work of Rel-17 IAB includes agreeing on the definition of topology-wide fairness.
Topology-wide fairness provides a mechanism for managing QoS such that the required QoS is met across the topology regardless of which part of the IAB network the UE is attached to. Variations of this definition are not excluded. The way of assessing success of the mechanism needs to be further discussed.
RAN2 does not discuss the expansion of DLE 2E flow control without input from RAN3.
Whether RAN2 is supposed to de-prioritize the splitting of data of a radio bearer into two or more paths needs to be further discussed. (RAN3 agreed on de-prioritizing multi-route support for data-splitting in IAB)

This supplementary note has discussed expansion of the topology, routing, and transport of Rel-17 IAB and focused on BSR, extension of a pre-emptive BSR, and a general framework for topology-wide fairness.

Discussion

### Expansion of BSR and Pre-Emptive BSR

### Expansion of LCG Field

In Rel-16, the number of LCGs of UE, i.e., up to 8 LCGs, has been reused in the IAB-MT. Many companies have proposed to increase the number of LCGs. Expansion of LCG fields reduces the number of LCHs per LCG and provides finer scheduling granularity, which appears to contribute to topology-wide fairness. Therefore, RAN2 is supposed to increase the number of LCGs. This can be applied to both a legacy BSR and a pre-emptive BSR.

Proposal 1: RAN2 is supposed to agree on increasing the number of LCGs of a BSR and a pre-emptive BSR.

Calculation of Buffer Size

For a legacy BSR, calculation of buffer size is clearly defined. This is based on data available in an MAC, an RLC and a PDCP. In the case of an RLC and a PDCP, the calculation procedure of the data amount is defined in each specification. In Rel-16, these mechanisms are reused for the IAB-MT. However, an IAB node has a BAP layer instead of a PDCP, and no data amount is calculated in the BAP. For this reason, the amount of data available for transmission is insufficient in the current specifications. For better scheduling for topology-wide fairness, a more accurate buffer size needs to be reported in a legacy BSR.

Proposal 2: RAN2 is supposed to discuss whether a data amount calculation procedure needs to be defined for the BAP.

According to Rel-16, although calculation of a buffer size of a pre-emptive BSR is highly dependent on the implementation of the IAB-DU, the specification provides a rough guideline that “a buffer size field identifies the total amount of data expected to reach the IAB-MT of a node that has triggered a pre-emptive BSR, and does not include the amount of data currently available at the IAB-MT.” Some IAB nodes are highly likely to report a larger buffer size than a buffer size that is expected to actually reach the node with a pre-emptive BSR. It may be difficult to configure the same principle for a child node and a parent node, such as in a case of multi-vendor deployment. This may cause inefficient allocation of radio resources, scheduling delays at the parents, and unfairness of resource requests between IAB-MTs. An IAB node that is configured to have dual connectivity is likely to be more ambiguous. For this reason, calculation of a buffer size of a pre-emptive BSR needs be more accurately defined.

Proposal 3: RAN2 is supposed to define calculation of a buffer size of a pre-emptive BSR.

Topology-Wide Fairness

Enhancement in topology-wide fairness is classified according to the following two approaches.
Local/distributed fairness optimization by a scheduler or the like
Centralized fairness optimization by updating of routing configurations and the like.

With respect to local/distributed fairness optimization, for example, information such as benefit metrics, number of remaining hops, and the like is provided to an IAB node to optimize the scheduler algorithm. It needs be noted that some solutions are strongly dependent on the implementation of each scheduler. If present, it is desirable to only define common/general information that is likely to be useful for all implementations.

On the other hand, in centralized fairness optimization, information of a congestion status or delay/latency or measurement values are reported to an IAB donor to determine, for example, updating of routing configurations. Therefore, this approach can be regarded as a type of MDT and SON.

In our view, these approaches have advantages and disadvantages. Although local/distributed approaches may be faster mechanisms, the advantages thereof are limited within a local connection and may vary due to implementation of the scheduler. Although a centralized approach may solve the entire topology/massive optimization, it may not work on fairness for each packet. Therefore, RAN2 is supposed to discuss which (or if both) approaches are more desirable to improve topology-wide fairness.

Proposal 4: RAN2 is supposed to discuss that enhancement in topology-wide fairness is realized by a local/distributed approach (for example, by each scheduler), a centralized approach (for example, by an IAB-donor-CU involved in updating of routing configurations), or both approaches.

1. A communication control method used in a cellular communication system, the method comprising:
performing, by a donor base station comprising a relay node as a subordinate, configuration whether the relay node causes a scheduler of the relay node to perform priority control in data packet transfer; and
causing, by the relay node, the scheduler to operate in accordance with the configuration.

2. The communication control method according to claim 1, wherein
the performing the configuration comprises performing, by the donor base station, configuration whether the relay node notifies a parent node or a child node of the relay node of assist information for performing priority control in data packet transfer by a scheduler of the parent node or the child node, instead of configuring whether to cause the scheduler of the relay node to perform data packet transfer control, and
the causing comprises causing the relay node to notify the parent node or the child node of the assist information in accordance with the configuration, instead of causing the scheduler to operate.

3. The communication control method according to claim 2, wherein
the assist information comprises information that is changed each time the assist information passes through a plurality of relay nodes comprising the relay node and/or congestion information indicating that the relay node is congested.

4. A communication control method used in a cellular communication system, the method comprising:
transmitting, by a relay node to a donor base station comprising the relay node as a subordinate, first information indicating throughput of each route, second information indicating the number of discarded data packets, or third information indicating reception of a notification relating to a radio link failure in a backhaul link; and
performing, by the donor base station, a predetermined operation based on the first information, the second information, or the third information.

5. The communication control method according to claim 4, wherein
the predetermined operation is updating routing information configured for the relay node.

6. The communication control method according to claim 4, further comprising:
configuring, by the donor base station, a validity period of data packet transfer for the relay node, wherein
the transmitting comprises counting, by the relay node, the number of the discarded data packets based on the validity period.

7. The communication control method according to claim 4, wherein
the notification relating to the radio link failure in the backhaul link comprises at least one selected from the group consisting of a notification transmitted in response to detection of the radio link failure in the backhaul link, a notification transmitted in response to detection of an operation to recover from the radio link failure in the backhaul link, and a notification transmitted in response to recovery from the radio link failure in the backhaul link.

8. A communication control method used in a cellular communication system, the method comprising:
transmitting, by a relay node interposed between a parent node and a child node, a pre-emptive buffer status report to the parent node; and
receiving, by the parent node, the pre-emptive buffer status report, wherein
the transmitting comprises storing, by the relay node, a first data amount of first data retained in the child node and a second data amount of second data retained in the relay node in different fields of the pre-emptive buffer status report.

9. The communication control method according to claim 8, wherein
the transmitting comprises storing, by the relay node, the first data amount in a first buffer size field of the pre-emptive buffer status report and storing the second data amount in a second buffer size field of the pre-emptive buffer status report.

10. The communication control method according to claim 8, further comprising:
configuring, by a donor base station comprising the relay node as a subordinate, a first logical channel group for the relay node, wherein
the transmitting comprises storing, by the relay node, the first data amount in a buffer size field corresponding to the first logical channel group, the buffer size field being a third buffer size field of the pre-emptive buffer status report.

11. The communication control method according to claim 10, wherein
the transmitting comprises storing the second data amount of the second data for which routing is confirmed in a buffer size field corresponding to a second logical channel group comprising a logical channel for transmitting the second data, the buffer size field being a fourth buffer size field of the pre-emptive buffer status report.

12. The communication control method according to claim 8, wherein
the transmitting comprises, by the relay node to the parent node, transmitting the first data amount by using the pre-emptive buffer status report and transmitting the second data amount by using a buffer status report without using the pre-emptive buffer status report.

13. The communication control method according to claim 8, wherein
the first data is data retained in an integrated access and backhaul (IAB)-mobile termination (MT) of the child node, and the second data is data retained in an IAB-distributed unit (IAB-DU) of the relay node.
